(19) United States
(12) Patent Application Publication
(10) Pub. No.: US 2007/0237681 A1
(43) Pub. Date: Oct. 11, 2007

(54) Nanostructures containing inorganic nanotubes and methods of their synthesis and use

(76) Inventors: Paul Boyle, London (GB); David Ruiz-Alonso, Cambridge (GB); Andrew Koehl, Cambridge (GB); Martyn Rush, Cambridge (GB); Russell Parris, Cambridge (GB); Ashley Wilks, Cambridge (GB)

Correspondence Address: MORGAN LEWIS & BOCKIUS LLP, 1111 PENNSYLVANIA AVENUE NW, WASHINGTON, DC, 20004, US

(21) Appl. No.: 11/239,165

(22) Filed: Sep. 30, 2005

(51) Int. Cl. G01N 30/96

(52) U.S. Cl. 422/88

(57) ABSTRACT

The invention relates to novel micro- or nanostructures incorporating nanotubes, wherein nanotubes are synthesized or grown directly in or on components of a micro- or nano-structure. In a particular embodiment, the invention relates to methods of synthesizing or growing nanotubes in a gas chromatography column and their use in portable gas chromatography devices.

### 1. FIELD OF THE INVENTION

The invention relates to novel methods of incorporating nanotubes for use in micro- or nano-devices. The invention further relates to incorporating nanotubes in micro or nano-devices and particularly synthesizing or growing nanotubes directly in or on components of a micro- or nano-device. In a particular embodiment, the invention relates to methods of synthesizing or growing nanotubes in a gas chromatography column and their use in portable gas chromatography devices.

### 2. BACKGROUND OF THE INVENTION

Gas Chromatography (“GC”) is an instrumental method for the separation and identification of a range of chemical compounds in numerous applications. Typically a sample is introduced via a heated injector to a separation column, and is carried through the column by an inert gas. Separation occurs in the column and the resulting separated components are detected upon leaving the column.

Separation involves the use of a stationary phase and a mobile phase. Components of a mixture carried in a mobile phase are differentially attracted to the stationary phase and thus move through the stationary phase at a different rate. In gas chromatography, the mobile is an inert carrier gas such as helium and the stationary phase is a solid or liquid coated on a solid support. Stationary phases can range from the very non polar polydimethylsiloxane to the highly polar polyethylene glycol. Compounds differentially retained in the stationary phase reach the detector at different retention times leading to a series of peak that indicate the compounds present.

There are a number of other factors combined that determine the rate at which a compound travels through the system; volatility and polarity of compound, column temperature, stationary phase, flow rate of the gas and length of the column. The longer the column, the longer it will take all compounds to elute. Longer columns are employed to obtain better separation.

A smaller column is desirable from the perspective of creating a portable, miniaturized detection system. Such a column can be manufactured using microsystem fabrication techniques, such as deep reactive ions etching (“DRIE”). Cheap columns can be manufactured in high volume using such techniques. Additionally a GC column could also be used as a pre-separation stage to another miniature analysis system such as a mass spectrometer or a field asymmetric ion mobility spectrometer. However reducing the size of the column reduces the compound separation and may lead to misidentification of compounds and an increase in false positives.

To offset the loss in performance resulting from a shorter column, the stationary phase can be improved to change the time compounds are differentially retained on the stationary phase. This can be achieved by increasing the surface area to volume ratio of the solid support the stationary phase is attached to. The compounds have greater interaction with the stationary phase and component separation is improved. To date techniques to reduce column length, while maintaining optimum separation and identification have not provided sufficient separation of compounds and therefore there remains the need to develop smaller shorter columns with sufficient surface area for use in nanostructures.

### 3. SUMMARY OF THE INVENTION

The present inventors have a developed methods and compositions to create a solid matrix inside the GC column with an extremely high surface area to volume ratio, which is coated with a stationary phase. The matrix is deposited in situ without the need for ‘packing’ beads coated with a stationary phase. This improves component separation, which allows the column to be reduced in size and integrated into miniature detection systems.

The invention encompasses a method of growing nanotubes, preferably inorganic or carbon nanotubes on a micro- or nano-structure, which comprises the following steps:

a) providing a first nanosubstrate;

b) coating a catalyst layer on a second nanosubstrate;

c) bonding the first nanosubstrate to the second nanosubstrate to form a micro- or nanostructure; and

d) growing nanotubes on a surface of said micro- or nano-structure.

Preferably, the growing of nanotubes is facilitated by using, for example, a source gas through a thermal chemical vapor deposition (CVD) process. More preferably, the thermal CVD is carried out under conditions of a reaction temperature of about 400° C. to about 600° C., atmospheric pressure, and a reaction time of about 1 to about 120 minutes.

In another embodiment, the invention encompasses a micro- or nanostructure device comprising:

a) a first nanosubstrate having a channel;

b) a catalyst layer on a second nanosubstrate, wherein the first nanosubstrate and second nanosubstrate are attached; and

c) a nanotube layer on a surface of said micro- or nano-substrate.

Another embodiment of the invention encompasses a method of fabricating micro- or nano-structures comprising nanotubes, the method comprising the steps of:

a) providing a first nanosubstrate having a patterned surface;

b) etching a channel into said surface of the first nanosubstrate;

c) providing a second nanosubstrate, wherein a catalyst layer is deposited on the surface of the second nanosubstrate;

d) annealing the catalyst layer of the second nanosubstrate to form catalyst islands;

e) bonding the first nanosubstrate and the second nanosubstrate together;

f) heating the entire structure in the presence of nanotube growth gases such that nanotubes form in the etched channel; and

optionally coating the nanotubes with a functional layer.

In another embodiment, the invention encompasses a micro- or nanostructure device comprising:

a) a single nanosubstrate having a channel with a catalyst layer; and

b) a nanotube layer on a surface of said nanosubstrate.

Another embodiment of the invention encompasses a method of fabricating micro- or nano-structures comprising nanotubes, the method comprising the steps of:

a) providing a single nanosubstrate having a patterned surface;

b) etching a channel into a surface of the nanosubstrate;

c) depositing a catalyst layer on the surface of the nanosubstrate;

d) annealing the catalyst layer of the nanosubstrate to form catalyst islands;

e) growing nanotubes on the nanosubstrate; and

optionally coating the nanotubes with a functional layer.

Another embodiment of the invention encompasses a method of fabricating micro- or nano-structures comprising nanotubes, the method comprising the steps of:

a) providing a single nanosubstrate having a patterned surface;

b) etching a channel into a surface of the nanosubstrate;

c) depositing a catalyst layer on the surface of the nanosubstrate;

d) annealing the catalyst layer of the nanosubstrate to form catalyst islands;

e) heating the entire structure in the presence of nanotube growth gases such that nanotubes form in the etched channel; and

optionally coating the nanotubes with a functional layer.

In yet another embodiment, the invention encompasses a gas chromatography column comprising:

a) a first nanosubstrate having a channel;

b) a catalyst layer on a second nanosubstrate, wherein the first nanosubstrate and second nanosubstrate are attached; and

c) a nanotube layer on a surface of said second substrate.

In another embodiment, the invention encompasses a gas chromatography column comprising:

a) a first nanosubstrate having channel with an inlet and outlet;

b) a catalyst layer on a second nanosubstrate; wherein the catalyst layer is annealed to create catalyst islands and wherein the first nanosubstrate and second nanosubstrate and bonded together; and

c) a carbon nanotube layer on a surface of said second nanosubstrate; and

d) optionally depositing a stationary phase on the surface of the dense entangled nanotube matrix.

The composistions and methods of the invention can also be implemented so as to be compatible with microelectromechanical manufacturing systems (“MEMS”) fabrication processes. Therefore, a key innovation associated with the present invention is the manufacturing of at least one nanotube on a MEMS substrate in a process suitable for large-scale manufacturing. The method of manufacturing provided by the present invention opens the door to many other applications where an individual carbon nanotube, or collection of individual carbon nanotubes, can be used as functional element(s) or device(s).

A technical advantage of the present invention is that the method of the present invention is designed to produce aligned nanotubes with controlled shape, diameter, wall thickness, length, orientation, surface area, and location of growth.

Another technical advantage of the present invention is that the method of the invention allows fabrication of a micro- or nano-structure with precise dimensions and location that will serve as a template for a carbon nanotube growth with controllable length, orientation, diameter, and location.

### 4. BRIEF DESCRIPTION OF THE DRAWINGS

Those skilled in the art will understand the invention and additional embodiments and advantages of the invention by studying the description of preferred embodiments below with reference to the following Figures, which illustrate the features of the appended claims:

FIG. 1 illustrates an overview of a GC system.

FIG. 2 illustrates the process for the direct growth of nanotubes on a micro- or nano-substrate of a micro- or nano-structure.

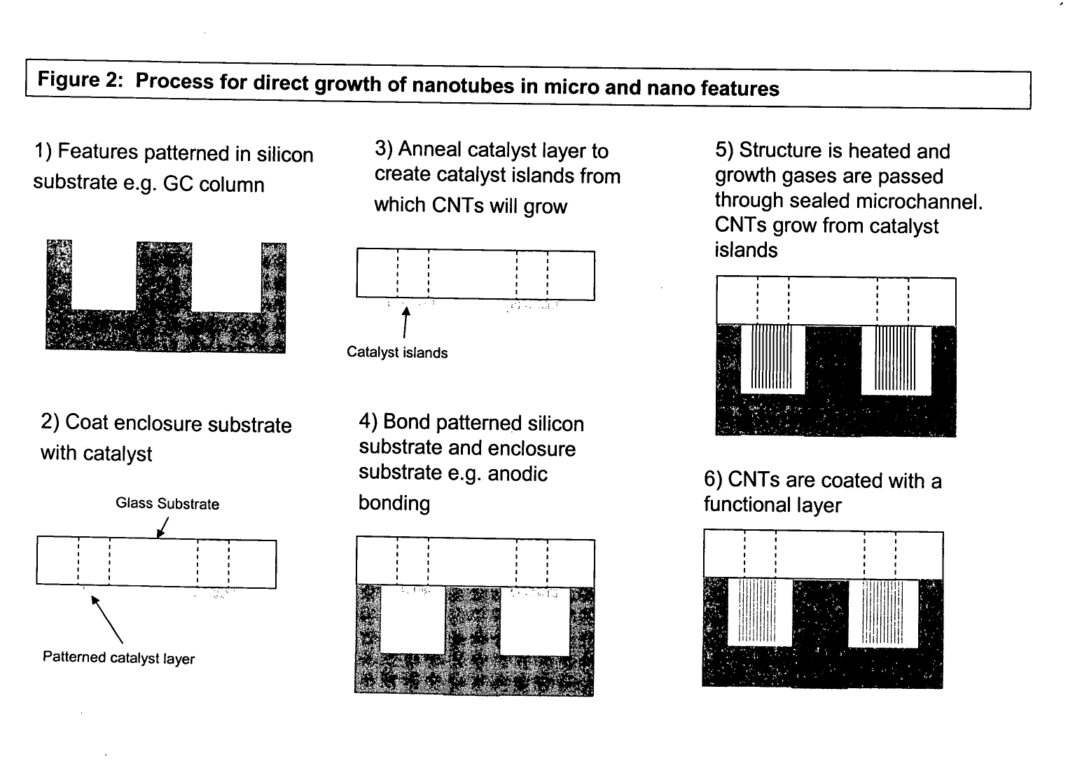

FIG. 3 illustrates a patterned nanosubstrate, wherein, for example, a pattern has been etched into the surface and illustrates the direction of the flow of gas.

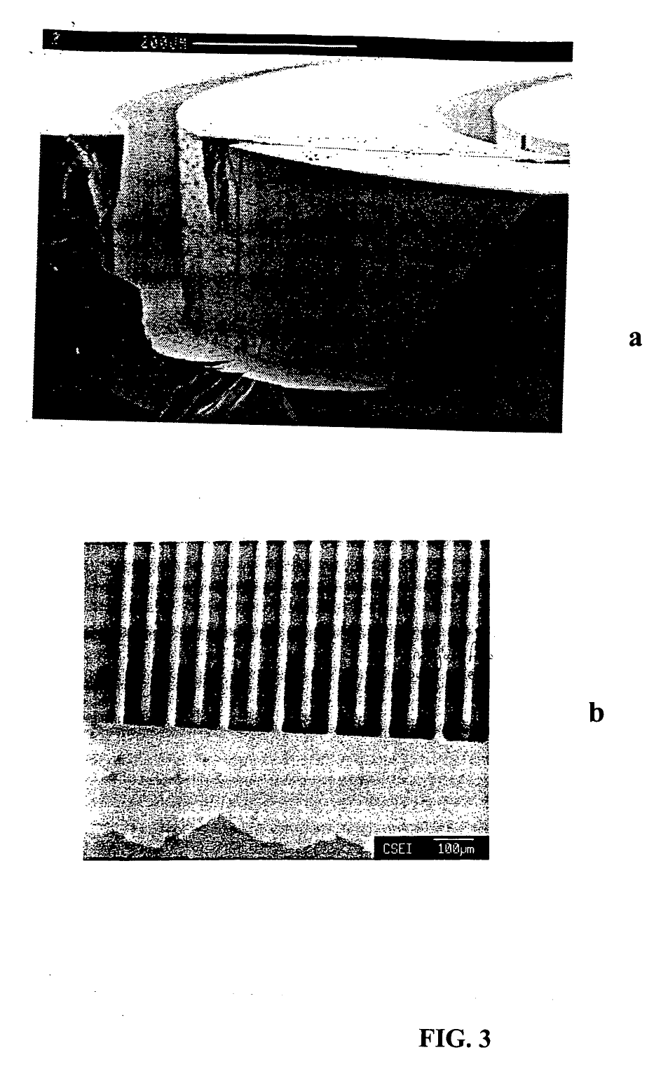

FIGS. 4-6 illustrate nanotubes that can be grown in the nanosubstrate of the micro- or nano-structure.

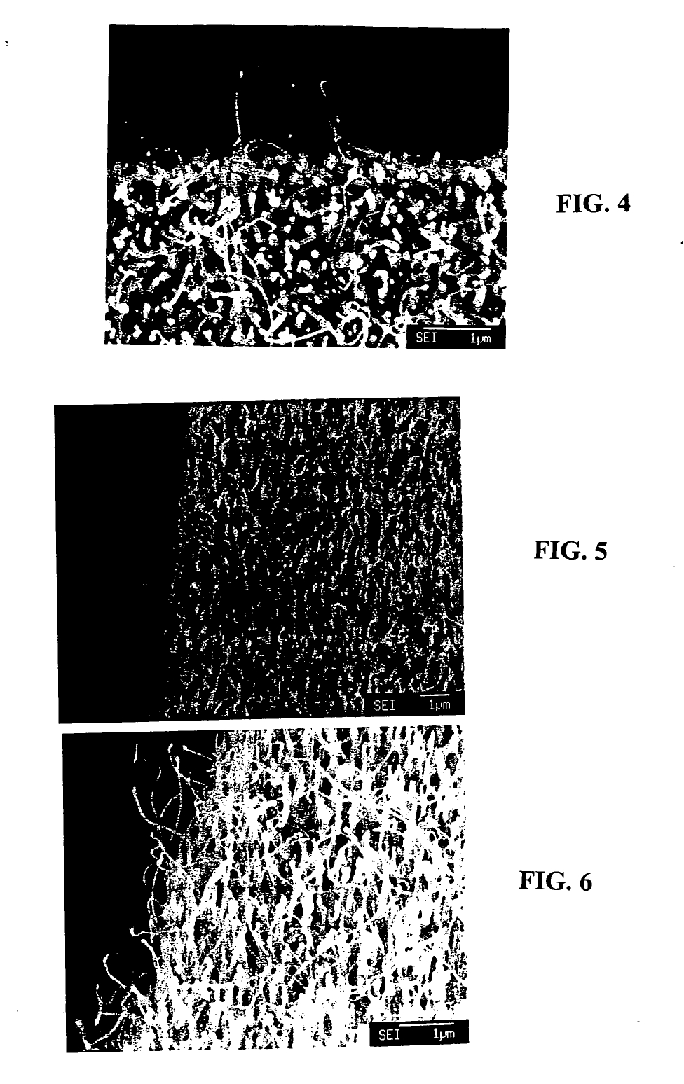

FIG. 7 illustrates a dense entangled nanotube matrix made using prior art techniques.

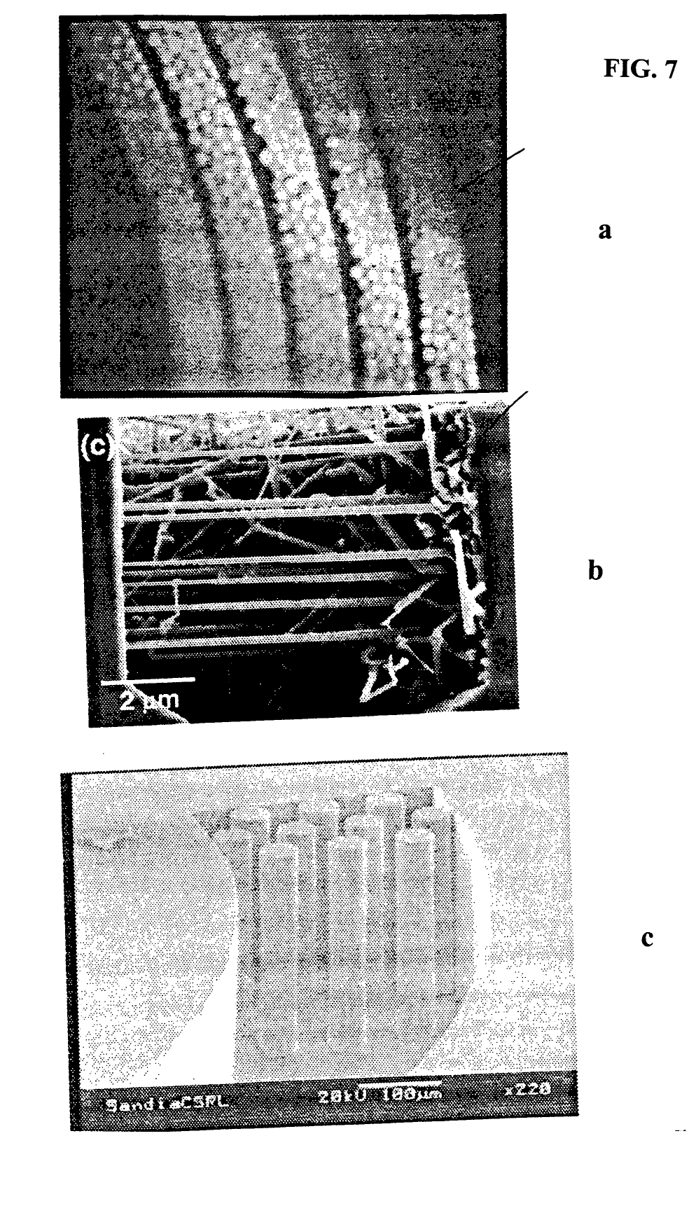

### 5. DETAILED DESCRIPTION OF THE INVENTION

5.1. Definitions

As used herein and unless otherwise stated, the term “aromatic hydrocarbon” refers to aromatic group comprised of hydrogen and carbon. Typical aromatic groups include, but are not limited to, groups derived from aceanthrylene, acenaphthylene, acephenanthrylene, anthracene, azulene, benzene, chrysene, coronene, fluoranthene, fluorene, hexacene, hexaphene, hexalene, as-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, trinaphthalene and the like. Preferably, an aryl group comprises from 6 to 24 carbon atoms.

As used herein and unless otherwise stated, the term “bonded” refers to connect or join two components by any physical or chemical means known to one of ordinary skill in the art.

As used herein and unless otherwise stated, the term “growing” means any technique known to those of ordinary skill in the art wherein nanotubes can be synthesized and as further described herein.

As used herein and unless otherwise indicated, the term “hydrocarbon” or “non-aromatic hydrocarbon” means a saturated, monovalent, unbranched (i.e., linear) or branched hydrocarbon chain. An “hydrocarbon” or “hydrocarbon group” further means a monovalent group selected from (C₁-C₈)alkyl, (C₂-C₈)alkenyl, and (C₂-C₈)alkynyl, optionally substituted with one or two suitable substituents. Preferably, the hydrocarbon chain of a hydrocarbon group is from 1 to 12 carbon atoms in length. Examples of hydrocarbon groups include, but are not limited to, (C₁-C₆)alkyl groups, such as methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, and hexyl, and longer alkyl groups, such as heptyl, and octyl. An alkyl group can be unsubstituted or substituted with one or two suitable substituents. The hydrocarbon may optionally be substituted with oxygen at any suitable position.

As used herein and unless otherwise indicated, the term “stationary phase” is a chromatographic stationary phase that can be added over the surface of the dense entangled nanotubes that are deposited in accordance with the embodiments of the invention. Examples of stationary phases of the invention include, but are not limited to, silicone, ester and other materials specifically manufactured or purified for use as chromatographic stationary phases. They ensure consistent analyses and much less bleeding and afford greater separation of compounds.

5.2. General Description of the Embodiments of the Invention

In one embodiment, the invention encompasses a micro- or nanostructure device comprising:

a) a first nanosubstrate having a channel;

b) a catalyst layer on a second nanosubstrate, wherein the first nanosubstrate and second nanosubstrate are attached; and

c) a nanotube layer on a surface of said micro- or nano-substrate.

In yet another embodiment, the invention encompasses a gas chromatography column comprising:

a) a first nanosubstrate having a channel;

b) a catalyst layer on a second nanosubstrate, wherein the first nanosubstrate and second nanosubstrate are attached; and

c) a nanotube layer on a surface of said second nanosubstrate.

In another embodiment, the invention encompasses a gas chromatography column comprising:

a) a first nanosubstrate having channel with an inlet and outlet;

b) a catalyst layer on a second nanosubstrate; wherein the catalyst layer is annealed to create catalyst islands and wherein the first nanosubstrate and second nanosubstrate and bonded together; and

c) a carbon nanotube layer on a surface of said second nanosubstrate.

In particular, the invention encompasses a method of growing carbon nanotubes on a micro- or nano-structure, which comprises the following steps:

a) providing a nanosubstrate;

b) coating a catalyst, preferably a metal catalyst, layer on said nanosubstrate;

b) forming a bonding layer on said metal catalyst layer; and

c) growing carbon nanotubes on a surface of said nanosubstrate by using a carbon source gas through a thermal chemical vapor deposition (CVD) process;

wherein the thermal CVD is carried out under conditions of a reaction temperature of about 400° C. to about 600° C., atmosphereic pressure, and a reaction time of about 1 to about 120 minutes.

Depending on its application the first and second nanosubstrate of the micro- or nano-substrate can independently be made of materials including, but not limited to, glass, plastic, ceramics, alumina, sapphire, silicon or mixtures thereof. The micro- or nano-substrate should be comprised of a material that allows direct growth of carbon nanotubes therein without any chemical or physical affect on the substrate. In a preferred embodiment, the micro- or nano-substrate is in the form of a column; more preferably a GC column.

Thus is a preferred embodiment, the first nanosubstrate is comprised of silicon and the second nanosubstrate is comprised of, for example, glass.

Examples of catalysts that can used in the methods of the invention include, but are not limited to, Fe, Co, Ni, Cu or an alloy thereof. In a preferred embodiment, the catalyst is a metal catalyst. The metal catalyst layer can be formed by techniques known in the art including, but not limited to, vacuum sputtering, CVD, physical vapor deposition (PVD), screen printing or electroplating. In a preferred embodiment, the metal catalyst layer is formed by electroplating. In a preferred embodiment, the catalyst layer is formed by CVD. The metal catalyst layer has a thickness of about 0.01 to about 100 microns, preferably from about 0.05 to about 75 microns and more preferably from about 0.1 to about 50 microns.

The catalyst layer after coated on the second nanosubstrate or first nanosubstrate if only a single nanosubtrate is used is then optionally annealed to create catalyst islands from which nanotubes will grow. If a first nanosubstrate and a second nanosubstrate are used the first and second nanosubstrates can be bonded together to form a bonded nanosubstrate, preferably through anodic bonding.

In order to facilitate growth of the nanotubes the bonded nanosubstrate or single nanosubstrate is heated and growth gases are passed through a sealed microchannel. Nanotubes then grow from the catalyst islands.

The source gas for forming the nanotubes depends on the type of nanotubes grown. For example, for growing carbon nanotubes, the source gas includes, but is not limited to, hydrocarbons or carbon monoxide. Preferably, the hydrocarbon is an aromatic hydrocarbon, a non-aromic hydrocarbon, or an oxygen-containing hydrocarbon.

Another embodiment of the invention encompasses a nanostructure device comprising:

a) a nanosubstrate having a channel;

b) a metal catalyst layer on a nanosubstrate; and

c) a carbon nanotube layer on a surface of said nanosubstrate.

Preferably, the nanostructure device is from about 50 micron to about 10 cm. Depending on its application, the micro- or nano-substrate can be made of materials including, but not limited to, glass, plastic, ceramics, alumina, sapphire, or silicon or mixtures thereof. The micro- or nano-substrate should be comprised of a material that allows direct growth of carbon nanotubes therein without any chemical or physical affect on the substrate. In a preferred embodiment, the micro- or nano-substrate is in the form of a column; more preferably a GC column. In an illustrative embodiment, the channel comprises an inlet and outlet to entrance and exit of the carbon growth gases.

Preferably, the metal catalyst that can used in the methods of the invention includes, but is not limited to, Fe, Co, Ni, Cu or an alloy thereof. The metal catalyst layer can be formed by techniques known in the art including, but not limited to, vacuum sputtering, CVD, physical vapor deposition (PVD), screen printing or electroplating. In a preferred embodiment, the metal catalyst layer is formed by electroplating. Preferably, the metal catalyst layer is formed using CVD. The metal catalyst layer has a thickness of about 0.01 microns to about 100 microns, preferably from about 0.05 to about 75 microns and more preferably from about 0.1 to about 50 microns.

In a preferred embodiment, the nanotubes are single walled carbon nanotubes, multi-walled carbon nanotubes or mixtures thereof. More preferably, the nanotubes are either single walled carbon nanotubes or multi-walled carbon nanotubes. Most preferably, the nanotubes are single-walled carbon nanotubes. In another preferred embodiment, the nanotubes are functionalized nanotubes, preferably the nanotubes are functionalized on their sidewalls, more preferably, the functionalized nanotubes are functionalized with a halogen or hydrocarbon and most preferably, the functionalized nanotubes are functionalized with a flourine.

Another embodiment of the invention encompasses a method of fabricating nanostructures comprising nanotubes, the method comprising the steps of:

a) providing a first nanosubstrate having a surface;

b) etching a channel into the surface of the first nanosubstrate;

c) depositing a catalyst of the surface of a second nanosubstrate;

d) annealing the catalyst layer to create islands;

e) bonding the first nanosubstrate and second nanosubstrate together;

f) heating the entire structure in the presence of nanotube growth gases such that nanotubes form in the etched channel.

Preferably, the nanostructure device is from about 50 microns to about 100 cm. Depending on its application the micro- or nano-substrate can be made of materials including, but not limited to, glass, plastic, ceramics, alumina, sapphire, or silicon or mixtures thereof. The micro- or nano-substrate should be comprised of a material that allows direct growth of carbon nanotubes therein without any chemical or physical affect on the substrate. In a preferred embodiment, the micro- or nano-substrate is in the form of a column; more preferably a GC column. In an illustrative embodiment, the channel comprises an inlet and outlet to entrance and exit of the carbon growth gases.

The etching can be accomplished by techniques known in the art including, but not limited to, deep reactive ion etching, potassium hydroxide (“KOH”) etching, or tetramethyl ammonium hydroxide (“TMAH”) etching.

Preferably, the metal catalyst that can used in the methods of the invention includes, but is not limited to, Fe, Co, Ni, Cu or an alloy thereof. The metal catalyst layer can be formed by techniques known in the art including, but not limited to, vacuum sputtering, CVD, physical vapor deposition (PVD), screen printing or electroplating. In a preferred embodiment, the metal catalyst layer is formed by electroplating. The metal catalyst layer has a thickness of about 0.01 to about 100 microns, preferably from about 0.05 to about 75 microns and more preferably from about 0.1 to about 50 microns.

In a preferred embodiment, the nanotubes are single walled carbon nanotubes, multi-walled carbon nanotubes or mixtures thereof. More preferably, the nanotubes are either single walled carbon nanotubes or multi-walled carbon nanotubes. Most preferably, the nanotubes are single-walled carbon nanotubes. In another preferred embodiment, the nanotubes are functionalized nanotubes, preferably the nanotubes are functionalized on their sidewalls, more preferably, the functionalized nanotubes are functionalized with a halogen or hydrocarbon and most preferably, the functionalized nanotubes are functionalized with a flourine.

In yet another embodiment, the invention encompasses a gas chromatography column comprising:

a) a nanosubstrate having channel with an inlet and outlet;

b) coating a metal catalyst layer on a microsubstrate;

b) a bonding layer on said catalyst metal layer; and

c) a carbon nanotube layer on a surface of said nanosubstrate.

Preferably, the nanostructure device is from about 50 micron to about 100 cm. Depending on its application the micro- or nano-substrate can be made of materials including, but not limited to, glass, plastic, ceramics, alumina, sapphire, or silicon or mixtures thereof. The micro- or nano-substrate should be comprised of a material that allows direct growth of carbon nanotubes therein without any chemical or physical affect on the substrate. In a preferred embodiment, the micro- or nano-substrate is in the form of a column; more preferably a GC column. In an illustrative embodiment, the channel comprises an inlet and outlet to entrance and exit of the carbon growth gases.

The etching can be accomplished by techniques known in the art including, but not limited to, deep reactive ion etching, KOH etching, or TMAH etching.

Preferably, the metal catalyst that can used in the methods of the invention includes, but is not limited to, Fe, Co, Ni, Cu or an alloy thereof. The metal catalyst layer can be formed by techniques known in the art including, but not limited to, vacuum sputtering, CVD, physical vapor deposition (PVD), screen printing or electroplating. In a preferred embodiment, the metal catalyst layer is formed by electroplating. Preferably, the metal catalyst layer has a thickness of about 0.01 to about 100 microns, preferably from about 0.05 to about 75 microns and more preferably from about 0.1 to about 50 microns.

In a preferred embodiment, the nanotubes are single walled carbon nanotubes, multi-walled carbon nanotubes or mixtures thereof. More preferably, the nanotubes are either single walled carbon nanotubes or multi-walled carbon nanotubes. Most preferably, the nanotubes are single-walled carbon nanotubes. In another preferred embodiment, the nanotubes are functionalized nanotubes, preferably the nanotubes are functionalized on their sidewalls, more preferably, the functionalized nanotubes are functionalized with a halogen or hydrocarbon and most preferably, the functionalized nanotubes are functionalized with a flourine.

In another preferred embodiment, the gas chromatograph is used in conjunction with another analytical device. Preferably, the other analytical device is a mass spectrometer or a field asymmetric ion mobility spectrometer.

C. Nanotubes of the Invention

The nanotubes that can be formed in the compositions and by the methods of the invention include any inorganic nanotube or carbon nanotube, see for example Adv. Mater. 2004, 16, 1497; Dalton Trans. 2003, 1; Angew. Chem, Int. Ed. 2002, 41, 2446, and Nature, 1991, 354, 56, each of which is incorporated by reference. Preferably the nanotubes are carbon nanotubes. Illustrative examples of inorganic nanotubes include, but are not limited to, nanotubes made from transition-metal chalcogenides, oxides, and halides, mixed-phase, metal-doped, boron-based, silicon-based, and pure metal nanotubes. See for example, Nature, 1992, 360, 444; J. Mater. Chem. 2005, 15, 1782; Science 1995, 269, 966, each of which is incorporated herein by reference. In particular, inorganic nanotubes include, but are not limited to, nanotubes of ZnO, GaN, BN, WS₂, MoS₂, WSe₂, MoSe₂, and TiO₂.

In addition, because the properties of nanotubes allow for changes in chirality, the invention further encompasses compositions comprising chiral nanotubes, for example a chiral GC column.

The nanotubes of the invention can be single-wall nanotubes or they can be a multi-wall nanotube having two, five, ten or any greater number of walls (i.e., concentric carbon nanotubes). Preferably, though, the nanotube is a single-wall nanotube, more preferably a single-wall carbon nanotube, and this invention provides a way of selectively producing single-wall carbon nanotubes in greater and sometimes far greater abundance than multi-wall carbon nanotubes. In one illustrative embodiment, the carbon nanotubes of the invention are single-wall carbon nanotubes greater than about 80% single-wall carbon nanotubes, preferably greater than about 90% single-wall carbon nanotubes, more preferably greater than about 95% single-wall carbon nanotubes and even more preferably greater than about 99% single-wall carbon nanotubes. In another illustrative embodiment, the carbon nanotubes are multi-wall carbon nanotubes greater than about 80% multi-wall carbon nanotubes, preferably greater than about 90% multi-wall carbon nanotubes, more preferably greater than about 95% multi-wall carbon nanotubes and even more preferably greater than about 99% multi-wall carbon nanotubes.

The nanotubes can also be derivatized in accordance with the intended embodiment. In preferred embodiments, the derivatization facilitates formation of more complex functional compounds with carbon nanotubes. Derivatization also enables complexing of Group VI B and/or Group VIII B metals on the nanotubes. Preferably, the nanotubes are derivatized on their sidewalls. For example, nanotubes of the invention can be carbon nanotubes having chemically derivatized side walls. The side-walls of the SWNT, by virtue of their aromatic nature, possess a chemical stability akin to that of the basal plane of graphite (see, e.g., Aihara, 1994, J. Phys. Chem., 98:9773-9776, incorporated herein by reference). In another illustrative embodiment, the present inventors have adapted technology developed in the fluorination of graphite (see, eg., Lagow, et al., 1974, J. Chem. Soc., Dalton Trans., 12:1268-1273) to the chemical manipulation of the SWNT side-wall by fluorinating high purity SWNT and then defluorinating them. Once fluorinated, single-wall carbon nanotubes can serve a staging point for a wide variety of side-wall chemical functionalizations, in a manner similar to that observed for fluorinated fullerenes (see, e.g., Taylor, et al., 1992, J Chem. Soc., Chem. Comm., 9:665-667 and U.S. Pat. No. 6,875,412, each of which is incorporated herein by reference). These fluorinated carbon nanotubes can then be reacted with species while in solution to either defluorinate or further functionalize them.

Depending on the intended use, the distribution of nanotubes can be tailored to obtain the desired characteristics, for example, surface area and thermal transport. The nanotubes preferably have an average separation (from central axis to central axis, as measured by SEM) of from 10 to 200 nm, more preferably 20 to 100 nm. Having close neighbors, means that the nanotubes can in one embodiment preferably be highly aligned. In another preferred embodiment, the nanotubes are sufficiently dense to cover the underlying support, as measured by SEM. In another preferred embodiments, the material includes nanotubes arranged in clumps on a support where there is a high degree of nanotube alignment within each clump. Preferably, the surface area of the article, as measured by BET/N₂ adsorption, is at least 50 m²/g nanotubes, in some embodiments 100 to 200 m²/g nanotubes; and/or at least 10 m²/g (nanotubes+support), in some embodiments 10 to 50 m²/g (nanotubes+support). Size and spacing of the carbon nanotubes can be controlled by techniques known in the art.

The carbon nanotubes are preferably at least 90 mol % C, more preferably at least 99 mol % C. The nanotubes may have a metallic nanoparticle (typically Fe) at the tips of the nanotubes. The nanotubes have a length to width aspect ratio of at least 3; more preferably at least 10. The nanotubes preferably have a length of about 1 μm, more preferably about 5 to about 200 μm; and preferably have a width of about 3 to about 100 μnm. In some preferred embodiments, as measured by SEM, about 50% of the nanotubes have a length of about 10 to about 100 μm. Preferably, of the total carbon, as measured by SEM or TEM, about 50%, more preferably, about 80%, and still more preferably, about 90% of the carbon is in nanotube form as compared to amorphous or simple graphite form.

D. Synthesis of Carbon Nanotubes

The invention encompasses a method for manufacturing carbon nanotubes as functional elements of microstructure devices with the ability to control the carbon nanotubes alignment, diameter, shape, length, surface area, and location. The method of the invention comprises the steps of preparing a substrate suitable for growth of a carbon nanotube. In a preferred embodiment, the microstructure device is a GC column. A nanosize hole or nanoscale catalyst is fabricated in a layer on the microstructure substrate in which a nanotube growth catalyst is deposited. A nanotube is then grown within the etched surface. In a preferred embodiment, inlet and outlet are etched in the substrate to allow introduction of carbon nanotube growth gases.

Chemical vapor deposition (“CVD”) is a chemical process for depositing thin films of various materials. In a typical CVD process the substrate is exposed to one or more volatile precursors, which react and/or decompose on the substrate surface to produce the desired deposit. Frequently, volatile byproducts are also produced, which are removed by gas flow through the reaction chamber.

The method of the invention allows fabrication of a micro- or nano-structure substrate containing carbon nanotubes with precise dimensions and location that will result in carbon nanotube(s) with desired size, orientation, and location. The method can be implemented so as to be compatible with applications, for example, but not limited to, MEMS fabrication processes, microfluidics, combinatorial chemistry, or nanocombustion devices.

The present invention need not be limited to a particular micro- or nano-structure or carbon nanotube functional element. The method of manufacturing provided by the present invention encompasses many other applications where an individual carbon nanotube, or collection of individual carbon nanotubes, can be used as functional element(s) or device(s). This allows the manufacture of carbon nanotube structures at a specified location, directly on a microstructure substrate, instead of forming the carbon nanotube structure elsewhere and then mounting the structure to the substrate.

Process parameters can be adjusted so as to make this nanotube fabrication process compatible with standard fabrication processes. This approach is suitable for fabricating the carbon nanotube in one continuous process, ideal for commercial manufacturing.

The method of the invention encompasses the individual process steps described below as employed to produce carbon nanotubes with controlled parameters. Additionally, the method includes the process consisting of the individual process steps listed below wherein an individual process step may be replaced by a similar process step that essentially achieves the same function.

An illustrative embodiment of the process of the invention is as follows:

(1) preparation of a micro- or nano-structure first substrate by providing patterns on the surface of the first substrate;

(2) etching a hole or well in a layer on a micro- or nano-structure second nanosubstrate;

(3) depositing a catalyst within the hole or well of the second nanosubstrate;

(4) annealing the catalyst layer to form catalyst islands;

(5) bonding the first and second nanosubstrates, preferably using anodic bonding;

(6) synthesizing the nanotube in the hole or well; and

(5) purifying the nanotubes.

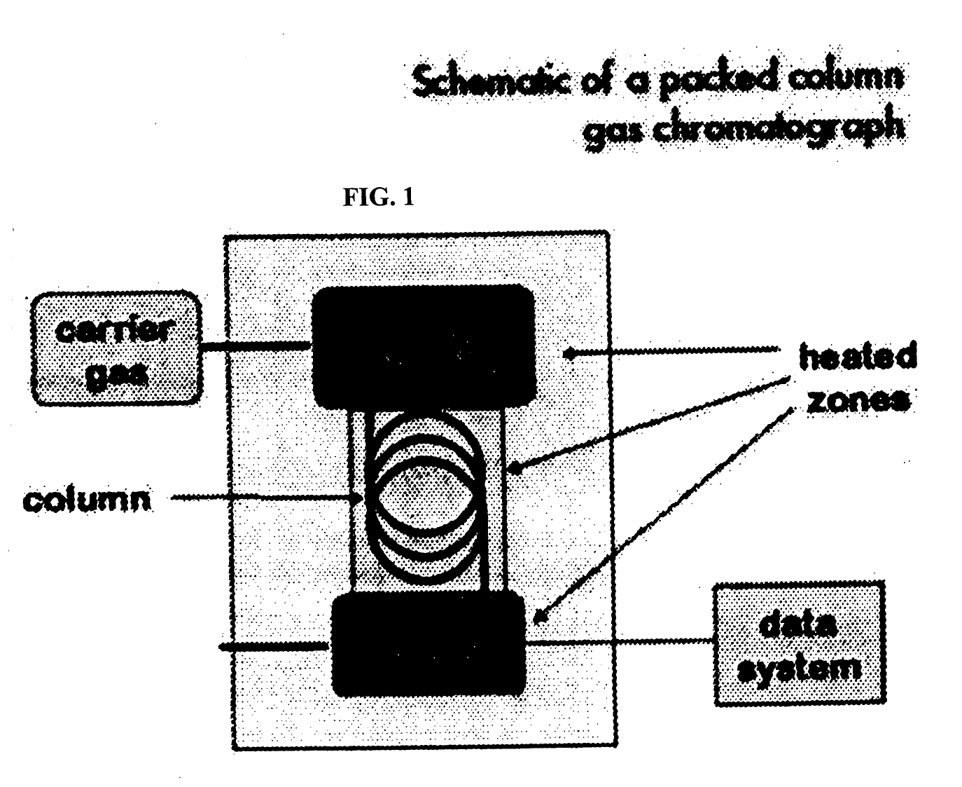

FIG. 1 illustrates the method of the present invention as a flow diagram. First, the micro- or nano-structure substrate is prepared for synthesis of a nanotube.

A hole or well with controlled shape, diameter and length is made in a layer at a specific desired location on the micro- or nano-structure first nanosubstrate. In a preferred embodiment, the hole or well is made by etching.

The size or diameter of the hole or well that is etched in the substrate is evaluated and reduced as needed with similar or same methods as used to fabricate it or with similar or same methods as used to coat it, as known to those skilled in the art. The etching can be accomplished by techniques known in the art including, but not limited to, deep reactive ion etching, KOH etching, or TMAH etching. Methods further include electrochemical deposition, chemical deposition, electro-oxidation, electroplating, sputtering, thermal diffusion and evaporation, physical vapor deposition, sol-gel deposition, and chemical vapor deposition.

A metal catalyst is then coated on a second nanosubstrate or a first nanosubstrate should only a single nanosubstrate be used. The catalysts of the invention includes, but is not limited to, Fe, Co, Ni, Cu or an alloy thereof. The metal catalyst layer can be formed by techniques known in the art including, but not limited to, vacuum sputtering, CVD, physical vapor deposition (PVD), screen printing or electroplating. In a preferred embodiment, the metal catalyst layer is formed by electroplating. Preferably, the metal catalyst layer has a thickness of about 0.01 to about 100 microns, preferably from about 0.05 to about 75 microns and more preferably from about 0.1 to about 50 microns.

A nanotube catalyst is grown within the etched hole or well of the substrate. Methods for placing this catalyst include electrochemical deposition, chemical deposition, electro-oxidation, electroplating, sputtering, thermal diffusion and evaporation, physical vapor deposition, sol-gel deposition, and chemical vapor deposition. This catalyst may be placed on a specific surface of the substrate, such as the bottom surface, or all surfaces of the substrate.

Carbon nanotubes with controllable shape, diameter, orientation, wall thickness and length and surface area, are synthesized from within an individual substrate. Methods for synthesizing include thermal deposition of hydrocarbides, a chemical vapor deposition process wherein a reaction time of said chemical vapor deposition process is manipulated to control a length of the carbon nanotube, and a chemical vapor deposition process wherein a process parameter of said chemical vapor deposition process is manipulated to control a wall thickness of the carbon nanotube. Afterwards, the carbon nanotubes are purified to remove impurities.

In a preferred embodiment, the method of the invention encompasses materials and processes that are as compatible with the microstructure materials and processes. These include, but are not limited to, CVD methods to grow carbon nanotubes, nanohole fabrication methods, and catalyst deposition methods.

In another preferred embodiment, the method of the invention uses materials that are compatible with existing microstructure technologies. Materials compatible with microstructure processes include, but are not limited to, crystalline silicon, polysilicon, silicon nitride, tungsten, and aluminum, for structural material; undoped silicon dioxide, doped silicon dioxide, polysilicon, and polymide, for sacrificial material; and fluorine-based acids, chlorine-based acids, and metallic hydroxides, for wet etching. The processes standard to existing microstructure technologies include: thin film deposition, oxidation, doping, lithography, chemical-mechanical polishing, etching, and packing. Other variations of the method involve process strategies for use when fabrication has to be interleaved with other (external to the microstructure fabrication) process steps, such as photoelectrochemical etching, electroplating, CVD, or etching.

1. The Column Substrate

Nanosubstrates of the first and second nanosubstrate can be of the same or different materials such as silicon, ceramic or glass. The catalyst can be applied in patterns such as islands as well as blanket coats on the substrates. The present method for making bundles of aligned nanotubes can also work on substrates such as glass, plastic, ceramics, alumina, sapphire, and silica, for example. The substrate should preferably be able to tolerate the high temperatures (e.g., about 500 to about 900° C.) used in the CVD process without melting or disintegrating. For best results, the substrate should have a rough and complex surface topology.

It is also noted that the substrate does not necessarily need to be silicon, although silicon, and particularly, porous silicon, is preferred. The substrate can also be quartz. In the present application, silicon, porous silicon, and quartz are understood to be refractory materials.

It is also noted that the substrate can have a rough texture which is neither smooth nor ‘porous’. Generally, however, extremely complex substrate surface topologies are preferred because they produce fast growing nanotubes with few defects that are strongly bound to the substrate.

2. Etching of Channels into the Substrate

The methods of the invention involve fabrication (e.g., etching) of an individual nanosize hole or well in a micro- or nano-substrate with the ability to control the nanotubes alignment, diameter, depth, and location. In a preferred embodiment, the method involves a nanosubstrate in the form of a thin column, for example a gas chromatography column, wherein nanotubes are directly grown.

The following technologies are capable of satisfying the above requirements: electrochemical or photoelectrochemical etching, micromachining and lithography. In addition, each technology offers several different variations of the nanotube growth method. In one embodiment, electrochemical (EC) and photoelectrochemical (PEC) etching can be used to fabricate an individual nanosize hole or well at a specific location on a substrate. The preferred method of etching is deep reactive ion etching. EC/PEC etching is a technology typically used to fabricate a porous silicon layer, where nano- and micro-size holes or wells with uniform diameters are evenly spaced out onto the substrate. In a preferred embodiment, a porous silicon layer is fabricated by anodization of silicon in diluted HF under controlled current density.

EC/PEC etching is used to control the number, diameter, shape, location, depth, and orientation of the holes. The existing EC/PEC etching process works well for mass fabrication of evenly distributed holes or wells with precise diameters at random locations on a substrate. Hole or well diameter is precisely controlled with the current flux. Therefore different hole shapes are possible, including tapered or other variable diameter (over length) holes. The depth of the hole or well etched using EC/PEC etching is dependent upon the diameter of the hole or well. This dependence is attributed to the fact that, during EC/PEC etching, the hole grows in both the axial and radial direction, not simultaneously, but in a staircase way. In most cases the EC/PEC fabricated hole is perpendicular to the substrate, but a sloped hole can also be fabricated by controlling the orientation of the substrate, the placement of the current source anode/cathode, and the light source. The present method enables manufactures of an individual nanosize hole or well at a specific desired location on a substrate, with control over its diameter, shape, and depth.

For best results materials are used that can be used to generate nanoporous silicon and which are also compatible with MEMS fabrication. For example, p doped silicon is suitable for both MEMS fabrication and porous silicon fabrication. Other MEMS and PEC compatible materials can also be used.

In another embodiment, the method of the invention uses micromachining technologies, such as ion milling, and e-beam micromachining, to fabricate an individual nanosize hole or well on specific location on a substrate. Existing ion milling (IM) and e-beam (EB) technologies can be used to fabricate holes with controllable diameter, at precise locations on a substrate (controllable location), and with controllable depth.

The advantage of using IM and EB technologies for fabrication is that they can produce holes or wells with diameters as small as 10 nm. In addition, the location and dimension of a feature, including a hole, can be achieved with nanometer dimensional tolerances. Additionally, depths of hundreds of nanometers can be achieved with IM and EM. Because of their long use in the micromachining industry, IM and EM technologies are compatible with standard MEMS processes, which makes them very attractive.

The method of nanotube fabrication of the present invention also accommodates use of lithographic technologies, such as optical and scanning probe lithography, to fabricate an individual nanosize hole or well at specific location on the substrate. Existing optical and scanning probe lithographic technologies can be used to fabricate holes or wells with controllable diameter, at precise locations on a substrate (controllable location), and with controllable depth. These methods include x-ray lithography, deep UV lithography, scanning probe lithography, electron beam lithography, ion beam lithography, and optical lithography.

Optical lithography is a technology capable of mass production of features, including the holes or wells with high throughput. Control of the location and dimension of features, such as the hole, can be performed with great critical dimension tolerances. This technology is compatible with standard microstructure processes. Since optical lithography only provides masking capabilities, the actual hole will be fabricated with etching. Fortunately, the existing etching and masking processes for optical lithography are very controllable. Therefore, the depth of the hole or well will depend on the masking and etching processes and is very controllable.

In another embodiment, Scanning Probe Lithography can be used to fabricate features, including the holes or wells, with great critical dimension tolerances of the location and dimension of the hole. An advantage of scanning probe lithography over optical lithography is that it can directly produce holes or wells with diameters as low as 10 nm, which is very suitable for small-diameter carbon nanotubes.

Knowledge of etchants properties is combined with the etching requirements and used to select the best etchant for the materials for the process. The etching requirements include the desired etching rates and the type of etching that we need, isotropic or anisotropic. The rates of anisotropic etching depend on the crystallography of the etched material, and anisotropic etching is mainly used for bulk-type microstructure fabrication. Isotropic etching is mainly used for surface-type micromachining fabrication. The selected etchant might be an individual etchant, diluted etchant or a combination of few etchants mixed proportionally.

The etchant must also be compatible with the substrate of the microstructure. Etchants known to be compatible with MEMS fabrication include KOH, HF, HF:HCl, H₃PO₄, and NaOH but need not be limited to these etchants. Timing of the wet etching is also used as a means to control the nanotube's length, namely how far it protrudes from the bottom of the substrate. Controlling nanotube length is to time the etching process so as to only expose the desired length of the nanotube and keep part of it buried in the substrate for structural support.

For the etchant and the substrate chosen, the etching rate can be empirically determined or is known. Knowing the etching rate, the etching time that results in uncovering the desired length of nanotube is calculated. The desired total length of the carbon nanotube is the length of the template. The length of nanotube that must remain embedded in the substrate determines the depth to which the template must be etched away.

Multilayer strategy as uncovering method is another variation involving the use of two layers of template substrate where the top layer is non-resistant to etchant and the bottom layer is resistant to etchant. This multilayer strategy makes the nanotube uncovering process self regulating. This approach also provides an effective way to precisely control the length of the carbon nanotube.

3. Catalyst Coating

Another embodiment of the invention encompasses a catalyst placed within an individual hole or well of the first nanosubstrate or on the surface of a second nanosubstrate. The function of the metallic catalyst in the process is to decompose the hydrocarbides and aid the deposition of ordered carbon. Common catalyst materials include, but are not limited to iron, cobalt, and nickel. The oxide may also be used as catalysts for growing carbon nanotubes. Materials used in MEMS fabrication, such as Si and SiO₂, are an example where a template made of Si which is electro-oxidized to produce SiO₂ or SiO catalyst. The Si has to be doped to become conductive. Electro-oxidized Si is more porous than thermally grown oxide, which may affect nanotube growth.

Before a carbon nanotube can be grown, the metallic catalyst should be deposited within it. A catalyst material in an individual template can be selectively deposited. Existing methods known to those skilled in the art can be used to deposit a metallic catalyst material evenly around the hole or well on a substrate. Existing catalyst deposition methods include electrochemical deposition, chemical deposition, electro-oxidation, electroplating, sputtering, thermal diffusion and evaporation, physical vapor deposition, sol-gel deposition, and chemical vapor deposition. Metallic catalysts can be deposited by chemical deposition immersing the substrate in Ni, Fe, and Co solutions (monomers). The substrate is then dried in H₂ atmosphere (or any oxidizing agent for the monomer) to allow uniform deposition of the metal catalyst on the inner walls of the hole. The desired catalyst thickness on the template is controlled by the concentration of catalyst-resinate in the solution.

In another embodiment, sol-gel deposition can be used to coat the inside of a template with a catalyst film. In this method, a porous aluminum membrane is first dipped into sol-gel solution. Afterward, the membrane is removed from the sol-gel solution and dried. The result is tubules or fibrils within the pores of the membrane. Tubules or fibrils are obtained depending on the temperature of the sol-gel solution. The wall thickness of the tubules depends on the immersion time. In the method of the present invention, the sol-gel method is used to deposit metal catalysts, such as Ni, Fe and Co, instead of semiconductor materials.

It is known that a carbon nanotube can be grown between a substrate and an anodic oxide film used as a catalyst via electro-oxidation. Changing the anodic oxidation time and the current density can control the inner diameter of the anodic oxide template. Changing the carbon deposition time can control the wall thickness of the nanotube. The length of the template determines the length of the carbon nanotube. In another embodiment, catalyst deposition can be achieved by immersing the substrate in a solution of a catalyst and applying electrical potential to electroplate the hole or well of the substrate.

Another embodiment of the invention encompasses the use of CVD to coat the walls of a nanosized template with Fe, Ni or Co catalyst. Required reaction temperature, amount of precursor, and deposition time are each monitored to achieve desired coating. Pore sol-gel deposition can be used to deposit metal catalysts. This process can produce short fibrils instead of tubules. The short fibrils can act as embedded catalytic particles. Electrochemical plating uses catalyst solutions with concentrations needed to coat the pore, the current densities that will produce electroplating and the time of deposition that is controlled. In another embodiment of the present invention, the above electrochemical plating process on a substrate with materials that can also be used with microstructure fabrication. To satisfy the geometrical constrains of this method, a cathode metal should be placed on the closed side of the hole or well.

As will be described further, one or more transition metals of Group VIB chromium (Cr), molybdenum (Mo), tungsten (W) or Group VIII B transition metals, e.g., iron (Fe), cobalt (Co), nickel (Ni), ruthenium (Ru), rhodium (Rh), palladium (Pd), osmium (Os), iridium (Ir) and platinum (Pt) catalyze the growth of a carbon nanotube when contacted with a carbon bearing gas such carbon monoxide and hydrocarbons, including aromatic hydrocarbons, for example, but not limited to, benzene, toluene, xylene, cumene, ethylbenzene, naphthalene, phenanthrene, anthracene or mixtures thereof, non-aromic hydrocarbons, for example, but not limited to, methane, ethane, propane, ethylene, propylene, acetylene or mixtures thereof, and oxygen-containing hydrocarbons, for example but not limited to, formaldehyde, acetaldehyde, acetone, methanol, ethanol or mixtures thereof. Mixtures of one or more Group VIB or VIIIB transition metals also selectively produce single-wall carbon nanotubes. The mechanism by which the growth in the carbon nanotube and/or rope is accomplished is not completely understood. However, it appears that the presence of the one or more Group VI B or VIII B transition metals on the end of the carbon nanotube facilitates the addition of carbon from the carbon vapor to the solid structure that forms the carbon nanotube. Applicants believe this mechanism is responsible for the high yield and selectivity of single-wall carbon nanotubes in the product and will describe the invention utilizing this mechanism as merely an explanation of the results of the invention.

Beside nickel, cobalt, iron and their alloys, copper (Cu) as catalyst for CNT growth has been investigated. It has been found that CNTs can be grown with copper by a CVD technique, and demonstrate very good field emission properties. The copper catalyst can be used to grow thinner CNTs to obtain a relatively high aspect ratio for field emission applications. Moreover, the lower growth rate with copper than with nickel is strongly dependent on the deposition time to provide a way for controlling the length or thickness of CNTs.

The present invention deposits a thin film catalyst using thick-film techniques. Thus, one can deposit a preferred amount of catalyst using inexpensive processes. Other means of preparing a copper thin film catalyst may be employed, such as evaporating, sputtering, and other physical vapor deposition coating techniques, but thickness sensitivity still remains so that it is relatively hard to control the growth of CNTs to meet field emission application. Therefore, copper thin film coated on small particles is used for CVD deposition.

In all of the above methods unwanted catalyst may be deposited outside of the hole or well where the carbon nanotube will grow and should be removed. Methods of removal include, but are not limited to:

(1) ion blowing by blowing ions at oblique angle with the substrate as not to remove the catalyst from within the hole;

(2) chemical submersion for a time interval too short to allow the rinsing of the catalyst within the hole but sufficient to rinse the surface; and

(3) removal of the catalyst. Preferably, the catalyst is removed by a lift off method. For example, a sacrificial layer is patterned in regions where nanotubes are not grown. The catalyst layer is then blanket deposited and when the sacrificial layer is etched it takes regions of the catalyst away with it. The catalyst can also be removed by magnetic removal.

4. Formation of Nanotubes in the Micro- or Nano-Structure

Synthesis of the nanotubes can be manipulated by chemical vapor deposition (CVD) process parameters. According to the microstructure desired one of ordinary skill in the art may examine how process parameters such as selection of a CVD precursor gas temperature and reaction time effect nanotube growth, which allows one to manipulate the parameters to achieve a desired result.

In one embodiment, carbon nanotubes can be synthesized by thermal deposition of hydrocarbides. The hydrocarbides used as precursors can be ethylene, acetylene, and methane. Carrier gases include, but are not limited to, argon and nitrogen.

In a preferred embodiment, the method uses CVD reaction temperatures ranging from about 500° C. to about 900° C. The specific reaction temperature used depends on the type of catalyst and the type of precursor. Energy balance equations for the respective chemical reactions are used to analytically determine the optimum CVD reaction temperature to grow carbon nanotubes. This determines the required reaction temperature ranges. The optimum reaction temperature also depends on the flow rates of the selected precursor and the catalyst.

In an illustrative embodiment of the method of the invention, the reaction time is used to control the wall thickness of the carbon nanotube. Since the growth of the nanotube is radially inward and fully contained within the template, longer reaction times produce nanotubes with thicker walls.

The reaction time is increased to achieve a thicker wall thickness some models for wall thickness growth assume that the carbon nanotube wall thickness growth rate is truly proportional to the CVD deposition time. Without being limited by theory, it is believed that the increased reaction time improves crystallization of the nanotube and decreases unwanted graphitization. A variation of the method involves tailoring the reaction time so as to produce a single-wall carbon nanotube and still obtain a highly crystallized carbon nanotube. In an illustrative embodiment of the method involves controlling wall thickness without depending on the reaction time by Ni catalyst with pyrene precursor, a process known to yield thin carbon nanotube walls regardless of the time of CVD reaction.

The quality of carbon nanotubes synthesized depends on the catalyst, the precursors, the reaction temperatures and the reaction times. Nanotube quality also depended on substrate geometry (diameter and pore orientation).

Longer reaction times produce longer nanotubes where the nanotubes can protrude past the surface of the pore. The reaction times have to be determined to produce carbon nanotubes that are about 1 μm long. Means to control nanotube wall thickness is gassification of the synthesized carbon nanotubes.

### 6. EXAMPLES

6.1. Synthesis of Carbon Nanotubes by Chemical Vapor Deposition

A catalyst organometallic Ni (other catalysts such as, for example, Co or Fe can also be used) is initially prepared for deposition by diluting a nickel resinate solution with toluene, creating solutions with 0.7%, 1.4%, and 3.3% Ni. The nanosubstrate is immersed into the Ni solutions and the solvent is allowed to evaporate, which will result in deposition of a film of the organometallic Ni on the surface of the nanosubstrate. Alternatively, the Ni solutions can be vaporized and the vapor deposited on the surface of the nanosubstrate. The coated nanosubstrate is then placed in a sealed tube furnace and the atmosphere is purged with Argon at room temperature. With the argon atmosphere, the furnace temperature is adjusted to 400° C. at a rate of about 10° C./min. Maintaining this oven temperature for 15 minutes thermally decomposes the organometallic compound and will result in the deposition of a Ni thin film.

Similarly, immersing the nanosubstrate into 0.1 M Fe(NO₃)₂ or Co(NO₃)₂ solutions and allowing water to evaporate resulted in the deposition of Fe(NO₃)₂ or Co(NO₃)₂ on the surface of the nanosubstrate. In an H₂ atmosphere at room temperature, the furnace temperature is adjusted to 580° C. for 3 h to produce Fe or Co inside the pores.

To prepare carbon nanotubes on the nanosubstrates, the nanosubstrate is placed in a CVD reactor. The reactor temperature is increased to 550° C. under an argon flow. The carbon nanotubes are synthesized by decomposition of either ethylene or pyrene. With ethylene, the argon flow is terminated after the temperature stabilizes. Using pyrene, ˜50 mg of pyrene is placed in the 200° C. zone a the reactor and Ar (50 sccm) is used as the carrier gas.

6.2. Synthesis of Inorganic Nanotubes by Chemical Vapor Deposition

Several methods exist for the synthesis of inorganic nanotubes. Each method may result in a different type, size and yield. The ‘type’ of tube refers to its atomic structure and chirality. ‘Size’ means the diameter and length of the tube and ‘yield’ refers to the purity of the product. A common method for synthesis of both inorganic and organic nanotubes is exposure to high temperatures by laser heating (See, for example, T. Laude, A. Marraud, Y. Matsui, and B. Jouffrey, ‘Long ropes of boron nitride nanotubes grown by a continuous laser heating’ (2000) Appl. Phys. Lett., 76, 3239, which is incorporated herein by reference in its entirety) or an arc discharge (See, for example, J. Cumings, A. Zettl, ‘Mass-production of boron nitride double-wall nanotubes and nanococoons’ Chem. Phys. Let. (2000) 316, 211 which is incorporated herein by reference in its entirety). Another technique is to substitute the atoms in an already fabricated tube by a substitution reaction (See, for example, W. Hang, Y. Bando, K. Kurashima and T. Sato, ‘Synthesis of boron nitride nanotubes from carbon nanotubes by a substitution reaction’ Applied Physics Letters (1998) 73, 3085-3087, which is incorporated herein by reference in its entirety). Template assisted synthesis is perhaps the most promising method, since it allows more precise control of the nanotube type (See for example, J. S. Suh, J. S. Lee, ‘Highly ordered two-dimensional carbon nanotube arrays’ Applied Physics Letters (1999) 75, 2047-2049. abstract; W. Shenton, T. Douglas, M. Young, G. Stubbs, S. Mann, ‘Inorganic-Organic Nanotube Composites from Template Mineralization of Tobacco Mosaic Virus’ (1999) Advanced Materials 11, 253. communication; Ming Zhang, Y. Bando, K. Wada, ‘Silicon dioxide nanotubes prepared by anodic alumina as templates’ (2000) J. Mater. Res. 15, 387, each of which is incorporated herein by reference in its entirety).

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

Various references have been cited herein, each of which is incorporated herein by reference in its entirety.

What is claimed is:

1. A nanostructure device comprising:
a) a patterned first nanosubstrate comprising a channel;
b) a catalyst layer on a second nanosubstrate; wherein said first nanosubstrate and second nanosubstrate are bonded together; and
c) an inorganic nanotube layer on a surface of said second nanosubstrate substrate.

2. The nanostructure device of claim 1, wherein said first nanosubstrate is comprised of glass, plastic, ceramics, alumina, sapphire, or silicon or mixtures thereof.

3. The nanostructure device of claim 1, wherein said second nanosubstrate is comprised of glass, plastic, ceramics, alumina, sapphire, or silicon or mixtures thereof.

4. The nanostructure device of claim 1, wherein said metal catalyst layer has a thickness of about 0.1 to about 50 microns.

5. The nanostructure device of claim 1, wherein said metal catalyst layer comprises Fe, Co, Ni, Cu and an alloy thereof.

6. The nanostructure device of claim 1, wherein said bonding of the first nanosubstrate and the second nanosubstrate is achieved by anodic bonding.

7. The nanostructure device of claim 1, wherein said inorganic nanotubes are comprised of ZnO, GaN, BN, WS₂, MoS₂, WSe₂, MoSe₂, or TiO₂.

8. The nanostructure device of claim 1, wherein the nanostructure is comprised of glass, plastic, ceramics, alumina, sapphire, silicon or mixtures thereof.

9. The nanostructure device of claim 8, wherein the nanosubstrate is in the form of a column.

10. The nanostructure device of claim 9, wherein the column is a GC column.

11. The nanostructure device of claim 10, wherein the GC column further comprises a stationary phase.

12. A gas chromatography column comprising:
a) a nanosubstrate having channel;
b) a catalyst layer on the microsubstrate, and
c) a carbon nanotube layer on a surface of said nanosubstrate.

13. The gas chromatography column of claim 12, wherein the nanostructure device is from about 50 microns to about 10 cm.

14. The gas chromatography column of claim 12, wherein the nanosubstrate is comprised of glass, plastic, ceramics, alumina, sapphire, silicon or mixtures thereof.

15. The gas chromatography column of claim 12, wherein the channel comprises an inlet and outlet.

16. The gas chromatography column of claim 12, wherein the channel comprises an inlet and outlet.

17. The gas chromatography column of claim 12, wherein the nanosubstrate is comprised of glass, plastic, ceramics, alumina, sapphire, or silicon or mixtures thereof.

18. The gas chromatography column of claim 12, wherein said catalyst layer has a thickness of about 0.1 to about 50 microns.

19. The gas chromatography column of claim 12, wherein said catalyst layer comprises Fe, Co, Ni, Cu and an alloy thereof.

20. The gas chromatography column of claim 19, wherein said inorganic nanotubes are comprised of ZnO, GaN, BN, WS₂, MoS₂, WSe₂, MoSe₂, or TiO₂.

21. The gas chromatography column of claim 20, wherein the inorganic nanotubes are functionalized nanotubes.

22. The gas chromatography column of claim 21, wherein the nanotubes are functionalized on their sidewalls.

23. The gas chromatography column of claim 22, wherein the functionalized nanotubes are functionalized with a halogen or hydrocarbon.

24. The gas chromatography column of claim 23, wherein the functionalized nanotubes are functionalized with a flourine.

25. The gas chromatography column of claim 12, further comprising a stationary phase.
